(19) United States
(12) Patent Application Publication
(10) Pub. No.: US 2022/0065999 A1
(43) Pub. Date: Mar. 3, 2022

(54) HYBRID TWO-DIMENSIONAL STEERING LIDAR

(71) Applicant: Voyant Photonics Inc., New York, NY (US)

(72) Inventors: Christopher T. PHARE, New York, NY (US); Sajan SHRESTHA, New York, NY (US)

(21) Appl. No.: 17/002,901

(22) Filed: Aug. 26, 2020

(51) Int. Cl. G01S 7/481; G02B 6/30

(52) U.S. Cl. CPC G01S 7/4818; G01S 7/4817; G02B 6/305

(57) ABSTRACT

An optical emitter device includes an emitter array comprising a plurality of end-fire tapers, each end-fire taper configured to selectively emit a respective beam of light. A lens system is configured to shape and direct each beam of light based on a position of the respective end-fire taper relative to an optical axis of the lens system. A rotating reflector, including an axis of rotation perpendicular to the optical axis of the lens system, is configured to redirect and scan the beams of light through a scanning range.

### TECHNICAL FIELD

The present disclosure relates to an optical emitter device, and in particular to an optical emitter device used in a light detection and ranging (LIDAR) system.

### BACKGROUND

On-chip photonics may easily integrate components such as lasers, detectors, and switches with compactness and low cost; however, to achieve beamforming and two-dimensional beam-steering, on-chip photonics consume a great deal of power and can be architecturally complex. On the other hand, using free space optics, e.g. lenses and mirrors, may be architecturally simple and power efficient for beamforming, and beam-steering, but other discrete components, such as lasers, receivers, and switches, are bulky and more expensive than their on-chip counterparts. With demanding applications that require very high resolution, or points per second, the aforementioned problems lead to either bulky and costly LIDAR systems made entirely of free space elements, i.e. multiple lasers, detectors, and switches, or power hungry, limited field-of-view, and low signal-to-noise ratio (SNR) lidar systems made with pure integrated photonics, e.g. an optical-phased-array. The present disclosure describes a low cost and compact hybrid lidar system architecture, in which the best of the two worlds are combined, where the photonics chip integrates the laser, detector, and switches, and the free space optics, e.g. mirror and lenses, are used for the beam-steering and beamforming.

Slow response times of thermo-optic switches used in on-chip photonics are a significant limiting factor in achieving ultrafast optical beam steering. On-chip optical phased arrays (OPA) also suffer from high insertion loss that results in high power consumption, low frame rate, and low signal-to-noise ratio.

One dimensional OPAs also require wavelength tuning to steer the beam in two dimensions. The wavelength tuning range is typically in the tens or hundreds of nanometers to get a field-of-view (FOV) more than 30°. However, wide bandwidth tunable lasers with narrow linewidth (for FMCW lidar) are difficult to design and fabricate.

### SUMMARY

Accordingly, a first apparatus includes an optical emitter device comprising:

a first emitter array comprising a plurality of first point emitters, each respective first point emitter configured to emit a respective first beam of light;

a first lens system configured to shape and direct each respective first beam of light based on a position of each respective first point emitter relative to a first optical axis of the first lens system; and

a rotating reflector configured to redirect each respective first beam of light at an angle to the first optical axis.

The apparatus may further comprise

a main substrate for supporting the plurality of first point emitters, wherein the plurality of first point emitters comprises a plurality of end-fire tapers; and

an optical waveguide structure, comprising:

a plurality of optical waveguide cores, each one of the plurality of optical waveguide cores comprising a main optical waveguide extending to a corresponding one of the end-fire tapers; and

cladding surrounding the plurality of optical waveguide cores.

### BRIEF DESCRIPTION OF THE DRAWINGS

Some example embodiments will be described in greater detail with reference to the accompanying drawings, wherein:

FIG. 1 is an top view in accordance with an example embodiment of the present disclosure;

FIG. 2A is a side view of the device of FIG. 1 with the rotating mirror in a first position;

FIG. 2B is a side view of the device of FIG. 1 with the rotating mirror in a second position;

FIG. 3A is a top view of a portion of the optical emitter chip the device of FIG. 1;

FIG. 3B is a top view of a portion of another exemplary embodiment of the optical emitter chip the device of FIG. 1;

FIG. 3C is a top view of a portion of another exemplary embodiment of the optical emitter chip the device of FIG. 1;

FIG. 3D is a top view of a portion of another exemplary embodiment of the optical emitter chip the device of FIG. 1;

FIG. 4 is a cross sectional view of an exemplary optical emitter chip of the device of FIG. 1;

FIG. 5 is a cross sectional view of another exemplary optical emitter chip of the device of FIG. 1;

FIG. 6 is a top view of the optical emitter chip of the device of FIG. 5;

FIG. 7 is a top view in accordance with an example embodiment of the present disclosure;

FIG. 8 is a side view of the device of FIG. 4; and

FIG. 9 is a side view of another example embodiment of the present disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

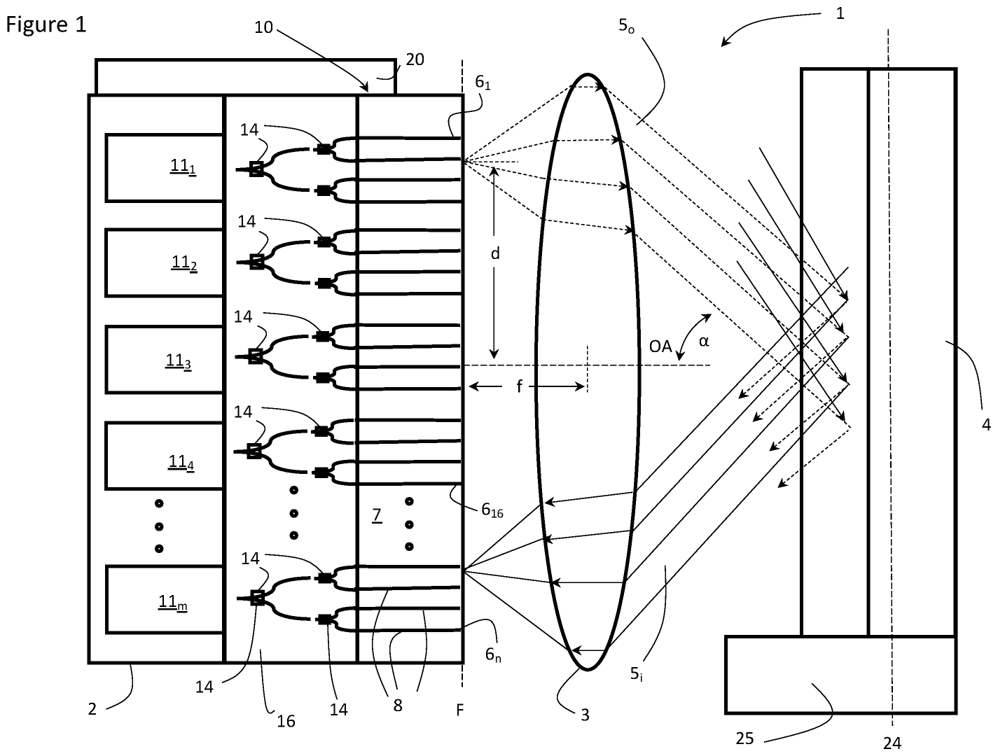

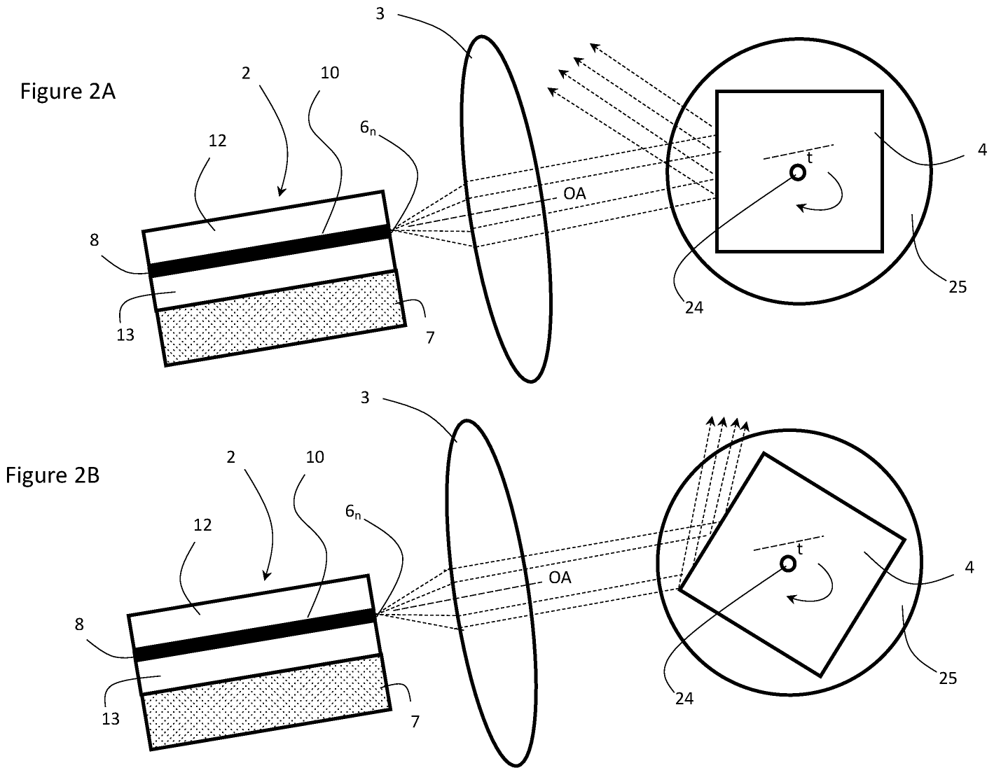

With reference to FIGS. 1, 2A and 2B, an apparatus includes an optical device 1, e.g. LIDAR, which in accordance with an exemplary embodiment comprises: on optical emitter chip 2, a lens system 3, and a rotating reflector, e.g. mirror, 4. For beamforming, one or more highly collimated output beams 5ₒ may be transmitted when a point emitter 6₁ to 6ₙ from the optical emitter chip 2 is placed proximate to or substantially on the focal plane F of the lens system 3 (infinite conjugation). The reverse propagation is also true based on the reciprocity theorem, whereby a parallel input beam 5ᵢ, e.g. one of the output beams 5ₒ reflected off of an object, shining on the lens system 3 will focus at a point spot to be captured by one of the point emitters 6₁ to 6ₙ, with a slight spread determined by lens aberration and diffraction. For beam-steering, the far-field beam angle α of the shaped, e.g. substantially collimated or focused, output beam 5ₒ depends on the location of the point emitter 6₁ to 6ₙ on the focal plane F relative to the longitudinal central optical axis OA of the lens system 3. The beam angle α is governed by the equation: α=arctan(d/f), where d is the distance from the center of the focal plane, i.e. the point where the optical axis OA coincides with the focal plane F, and f is the focal length of the lens system 3. Therefore, a full LIDAR system may be implemented by placing the optical emitter chip 2 of point emitters 6₁ to 6ₙ on or near the focal plane F of the lens system 3, then using a controller 20, selectively switch on and off selected and unselected point emitters 6₁ to 6ₙ, respectively, to steer the one or more output beams 5ₒ in the desired directions at the desired beam angles α. This method is fundamentally different than optical phased arrays as the relative optical phase between the emitters does not need to be controlled, and only one point emitter 6₁ to 6ₙ may be turned on at a time. Moreover, a plurality of point emitters 6₁ to 6ₙ may be activated simultaneously or sequentially by the controller 20 for transmitting multiple output beams 5ₒ pointing in different directions, i.e. at different beam angles α₁ to αₙ.

The optical emitter chip 2 may include: a main substrate 7 for supporting an optical waveguide structure, including an optical emitter array 10 comprising a plurality of optical waveguide cores 8 surrounded by cladding, each optical waveguide core 8 comprising a main optical waveguide core coupled to and ending with one of the point emitters 6₁ to 6ₙ. Ideally, the point emitters 6₁ to 6ₙ are arranged into an array of point emitters 6₁ to 6ₙ comprising a column (or row) of aligned point emitters 6₁ to 6ₙ. Preferably, the point emitters 6₁ to 6ₙ comprise end-fire tapers 9. The optical emitter chip 2 may include the optical waveguide structure, comprised of one or more optical waveguide layers configured to form the optical waveguide cores 8 with the end-fire tapers 9 coupled at outer ends thereof, all surrounded by cladding, i.e. a material with a lower index of refraction. As seen in FIGS. 2A and 2B, the optical emitter array 10 including the point emitters 6₁ to 6ₙ, the optical waveguide cores 8 and the end-fire tapers 9 may be coplanar with the optical axis OA of the lens system 3. The optical waveguide cores 8 and the end-fire tapers 9 may comprise silicon (Si) or silicon nitride (SiN), or both Si and SiN or any other suitable optical waveguide core material. The optical waveguide structure may be mounted on, e.g. grown on top of, the main substrate 7 with upper and lower cladding 12 and 13 surrounding the optical waveguide cores 8 and the end-fire tapers 9. The upper and lower cladding 12 and 13 may be comprised of on oxide material, such as silicon dioxide (SiO₂), e.g. 2-5 μm thick, and the main substrate 7 may be comprised of silicon, quartz or any suitable material. At least some of the end-fire tapers 9 may be between 25 μm and 400 μm in length and taper down, e.g. by 25% to 75%, preferably by about 50%, from the original width of the optical waveguide core 8, e.g. between 400 nm and 500 nm wide by between 200 nm and 250 nm thick, to a tip with a width of between 100 nm and 400 nm and the original thickness, e.g. between 200 nm and 250 nm, although the thickness may also be tapered to less than the optical waveguide core 8, if required. Preferably, the end of the end-fire tapers 9 may be symmetrical, e.g. square (200 nm×200 nm), to ensure that the TE and TM modes are substantially the same size at the end-fire tapers. At least some of the end-fire tapers 9, e.g. point emitter 65, may comprise reverse tapers, which expand, at least in width, from the original dimensions, e.g. width, of the optical waveguide core 8 to a wider width, e.g. 2× to 10× wider or to between 1 μm and 4 μm in width. The thickness may also expand, if required. Some of the end fire tapers 9 may be narrowing in width and some of the end fire tapers 9 may be widening in width. Some of the end fire tapers 9 may narrow more or less than other end fire tapers 9, and some of the end fire tapers 9 may widen more or less than the other end fire tapers 9.

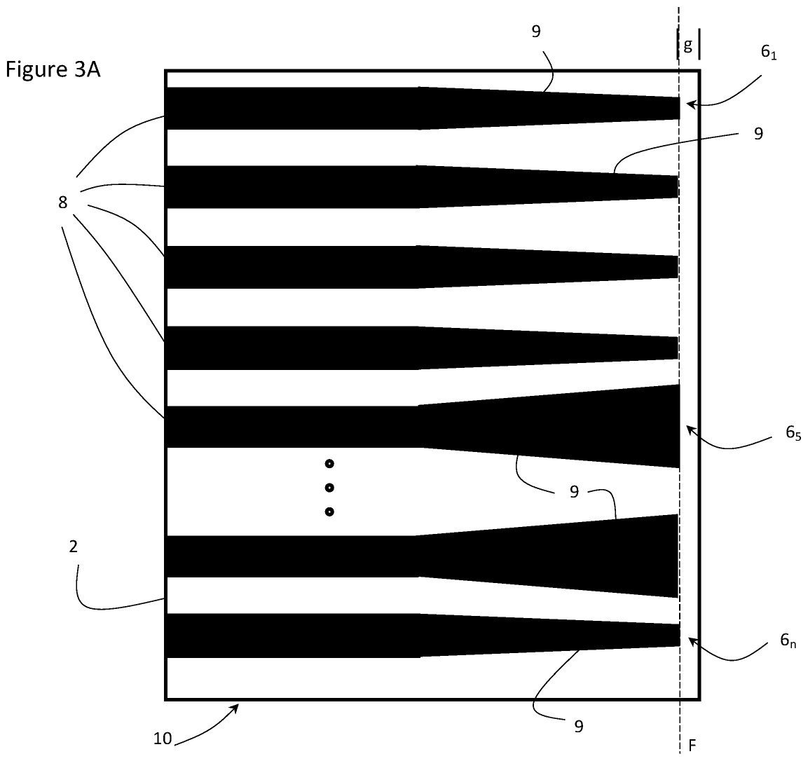

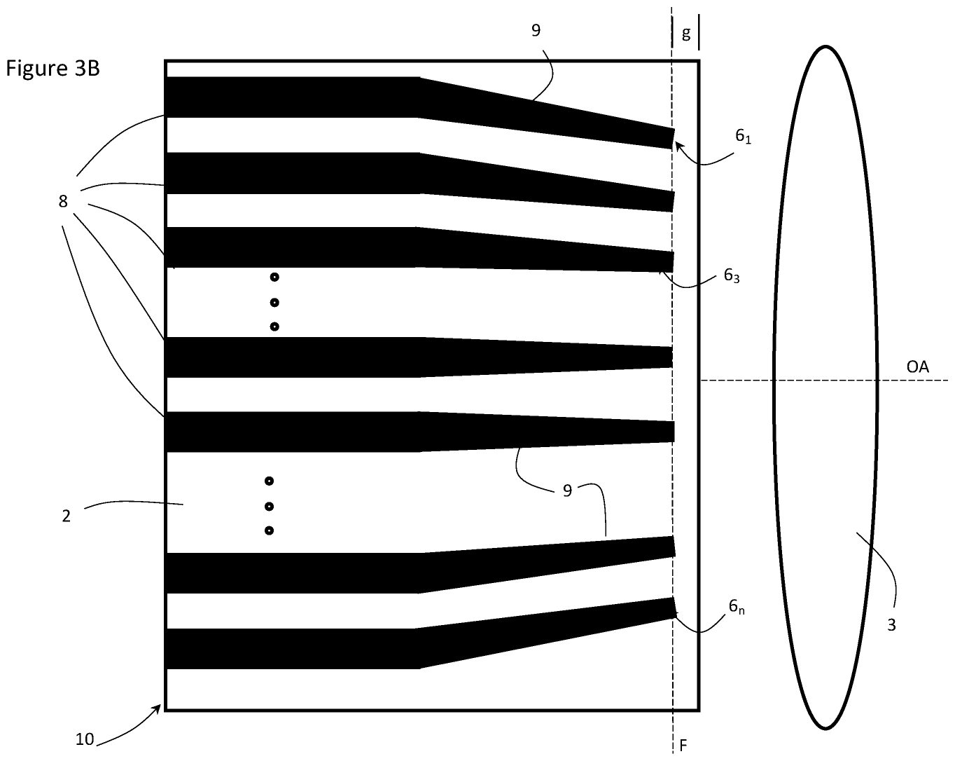

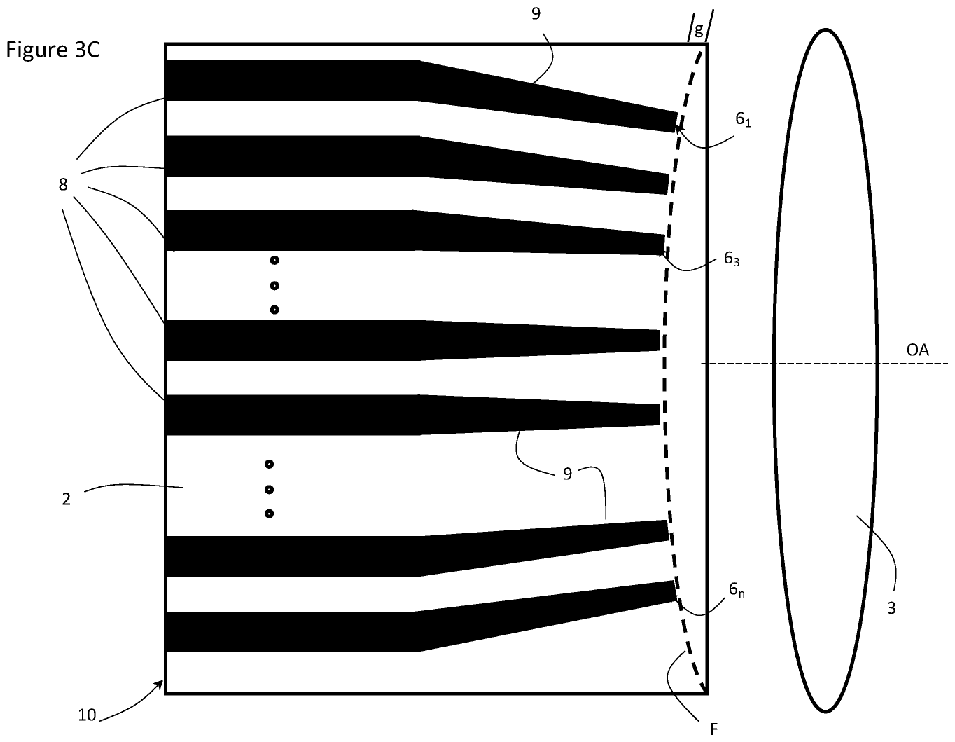

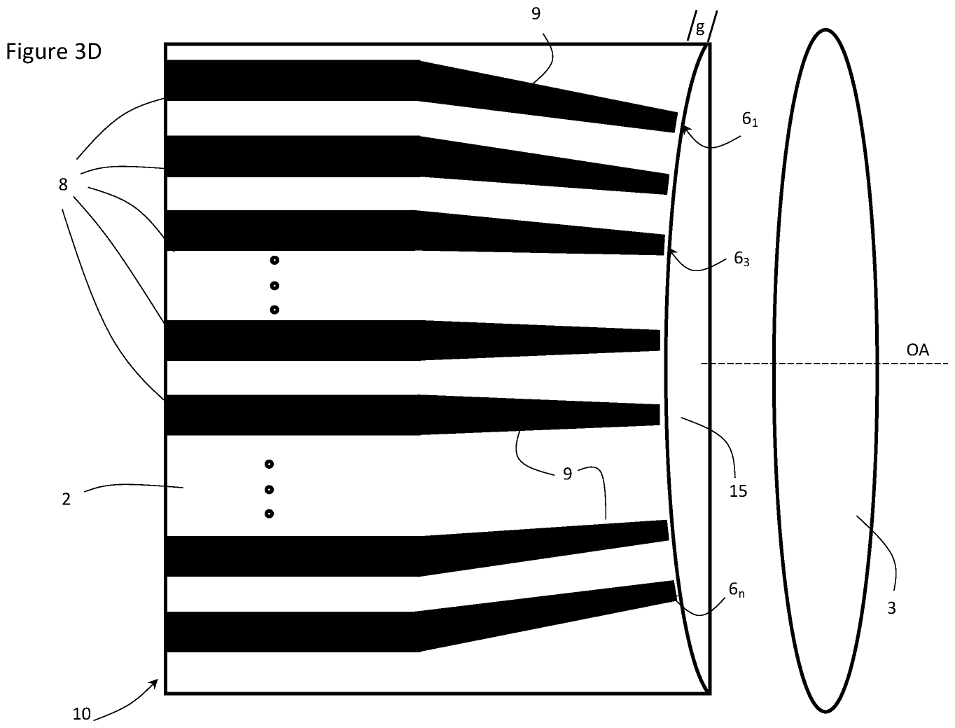

With reference to FIGS. 3A to 3D, there may be a small gap g comprising the same material as the cladding between the edge of the optical emitter chip 2 and the end of each end-fire taper 9. The gap g may be 0 nm up to 5 μm, preferably 500 nm to 1 μm. The gap g may be the same or different for some or all of the end-fire tapers 9. With reference to FIG. 3B, some of the end-fire tapers 9 may be configured to extend and terminate at an acute angle to the waveguide core 8 and/or a longitudinal central axis of the optical emitter chip 2, and/or the optical axis OA of the lens system 3. In other words, a longitudinal axis of the end-fire taper 9 is disposed at an acute angle relative to a longitudinal axis of the waveguide core 8 and/or the optical axis OA of the lens system 3. In this way, the chief ray of the light emitted from the end-fire taper 9 towards the lens system 3, or focused from the lens system 3 to the end-fire taper 9, may be tilted from the optical axis OA, i.e. the lens system 3 does not need to be image-space telecentric. Such a property may greatly simplify the design of the lens system 3.

Ideally, some or all of the end-fire tapers 9 are disposed at an acute angle such that the light emitted from the end-fire tapers 9 into free space is parallel to the designed chief ray angle of the lens system 3 at the location in the image plane corresponding to the end-fire taper 9. Some of the end-fire tapers 9 may be configured to extend substantially towards the optical axis OA and/or the longitudinal central axis of the optical emitter chip 2, i.e. the optical emitter array 10. Some of the end-fire tapers 9 may extend at a greater acute angle than other end-fire tapers 9. Preferably, the farther from the optical axis OA of the lens system 3 the greater the acute angle. Accordingly, the gap g may be varying in length along the array of end-fire tapers 9. The ends of each end-fire taper 9 may extend to the same distance from the edge of the optical emitter chip 2, i.e. the same gap length g, whereby each point emitter 6₁ to 6ₙ is substantially along or proximate to a straight focal plane F. Accordingly, some of the end-fire tapers 9 may have a different length than other end-fire tapers 9, and in particular, the end-fire tapers 9 at the outer edges of the optical emitter chip 2 are longer than the end-fire tapers 9 in the middle of the optical emitter chip 2, and/or the end fire tapers 9 gradually increase in length starting with shorter end-fire tapers 9 in the middle of the optical emitter chip 2, e.g. along the longitudinal central axis of the optical emitter chip 2 and/or the optical axis OA of the lens system 3, and ending at the outer end-fire tapers 9 with longer end-fire tapers 9. Alternatively, the end-fire tapers 9 may be made all the same length, but the main optical waveguide cores 8 extended differing lengths to accommodate the differing gaps g between the end-fire tapers 9 and the edge of the optical emitter chip 2. The optical waveguide cores 8 and the end-fire tapers 9 may also be joined by a gradual bend rather than a sharp transition. In some embodiments the differing gap length g may be accommodated by differing radii or lengths of these gradual bends. The ends of the end-fire tapers 9 may be perpendicular to the edge of the optical emitter chip 2 and/or perpendicular to the longitudinal central axis of the end-fire taper 9.

With reference to FIGS. 3C and 3D, some or all of the end-fire tapers 9 may be disposed such that each point emitter 6₁ through 6ₙ is substantially along or proximate to a curved focal plane F, corresponding to the curved focal plane F of the lens system 3. This curved focal plane F may be approximately spherical, corresponding to a non-zero Petzval sum of the lens system 3, or may be aspheric. The lens system 3 and shape of the focal plane F optimally may be co-designed such that the curvature of the focal plane F can help to reduce optical aberrations in the lens system 3 or simplify its design, e.g. allow the lens system 3 to comprise fewer elements.

With reference to FIG. 3D, the edge of the optical emitter chip 2 may be further etched down to form a trench 15, a substantially curved edge of which may be substantially along or parallel to the curved focal plane F, with the end-fire tapers 9 ending proximate to the edge of the curved trench 15, e.g. with the gap g therebetween. The ends of each end-fire taper 9 may extend to a same distance from the edge of the optical emitter chip 2, i.e. the same gap length g, whereby each point emitter 6₁ to 6ₙ is substantially along or proximate to the curved focal plane F. The trench 15 may also be fully etched away through the upper cladding 12 and the lower cladding 13, and optionally the substrate 7, if necessary, to avoid the light coming out of the end-fire tapers 9 hitting the bottom surface of the trench 15, e.g. when the curve of the trench 15 has a large sagitta. Alternatively, the trench 15 may be partially etched and the substrate 7 thinned from the back until no material remains in the area defined by the trench 15. For sufficiently small sagitta, a partial etch of the trench 15 alone may be sufficient. The ends of the end-fire tapers 9 may be directed, i.e. the longitudinal central axis thereof may be, substantially perpendicular or at an acute angle to the tangent of the edge of the trench 15. The edge of the trench 15 may be curved, e.g. colinear or parallel to the curved focal plane F, or include a series of steps, e.g. one step for each point emitter 6₁ to 6ₙ. Accordingly, the gap g of the cladding material, i.e. between the end of the end-fire taper 9 and the curved trench 15, may again have substantially the same length of cladding material for each end-fire taper 9.

With reference to FIGS. 3A through 3D, which illustrates a section of the optical emitter array 10 on the optical emitter chip 2, the positions of the point emitters 6₁ through 6ₙ may be spaced regularly, i.e. a same distance apart, or irregularly, i.e. different distances apart, along the direction perpendicular to the optical axis OA or the edge of the optical emitter chip 2. The position of the point emitters 6₁ to 6ₙ with respect to the optical axis OA, combined with the design, i.e. focal length, of the lens system 3, sets the beam angle α of the output beam 5ₒ leaving the lens system 3 and travelling into free space. In some embodiments, the point emitters 6₁ to 6ₙ, i.e. the end-fire tapers 9, may be deliberately spaced irregularly to address a non-uniform family of angles with the output beams 5ₒ. In some embodiments, the lens system 3 may have distortions such that a regular spacing of point emitters 6₁ to 6ₙ may create an irregular angular spacing of the output beams 5ₒ. To compensate for such distortions, the spacing of the point emitters 6₁ to 6ₙ i.e. the end-fire tapers 9, may be varied and made irregular in the opposite direction so that the angular spacing is substantially uniform leaving the lens system 3.

One or more of the modifications to the end-fire tapers 9 and facet design described above may be combined in a single embodiment. Particularly, a layout of the point emitters 6₁ to 6ₙ that allows for focal plane curvature, arbitrary chief ray angle, and corrected distortion significantly relieves constraints on the design of the lens system 3, and may allow it to be constructed of a single element, even at low f-number.

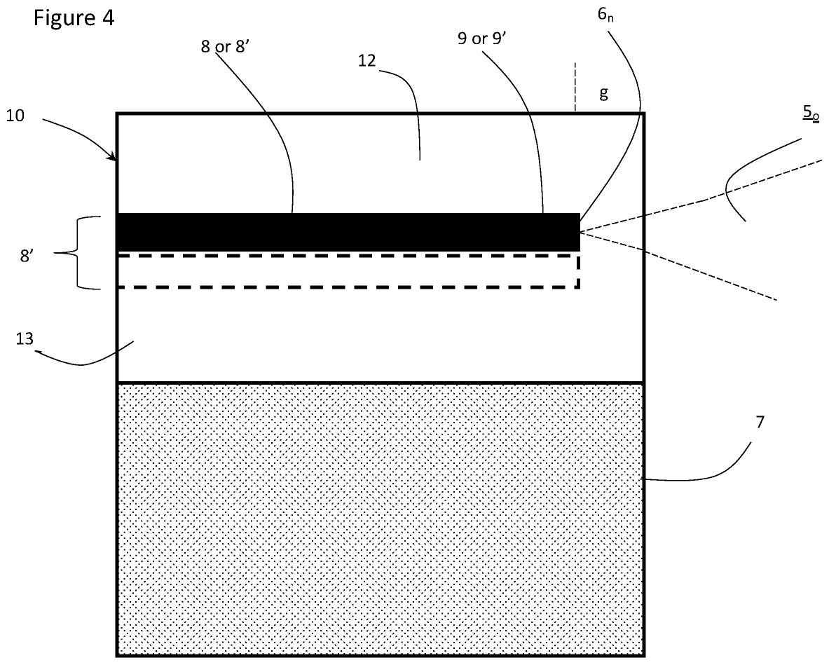

FIG. 4 illustrates a cross section of the optical emitter chip 2, i.e. showing one of the point emitters 6ₙ in the optical emitter array 10. The array of point emitters 6₁ to 6ₙ may include some or all of the optical waveguide cores 8 comprised of one or two optical waveguide layers configured to form singular or bi-layer optical waveguide cores 8 or 8′, respectively, and singular or bi-layer end-fire tapers 9 or 9′, respectively. Including a second layer of optical waveguide core material enables mode profile engineering that may also enable modification of the NA of the point emitters 6₁-6ₙ, i.e. launching light into a coupled mode that has a broader mode spread results in a smaller NA. The bi-layer optical waveguide cores 8′ and the bi-layer end-fire tapers 9′ may be comprised of two similar optical waveguide core materials with similar indexes of refraction, e.g. both silicon (Si) or both silicon nitride (SiN), or of two different optical waveguide core materials with different indexes of refraction, such as a first index of refraction, e.g. Si, larger than a second index of refraction, e.g. SiN, or any other suitable optical waveguide core material. The optical waveguide cores 8 or 8′ may be mounted on, e.g. grown on top of, the main substrate 7 with upper and lower cladding 12 and 13 surrounding and between the dual optical waveguide cores 8′ and end-fire tapers 9′. The upper and lower cladding 12 and 13 may be comprised of on oxide material, such as silicon dioxide (SiO₂), e.g. about 2-4 μm thick, preferably about 3 μm thick, and the main substrate 7 may be comprised of silicon or any suitable material.

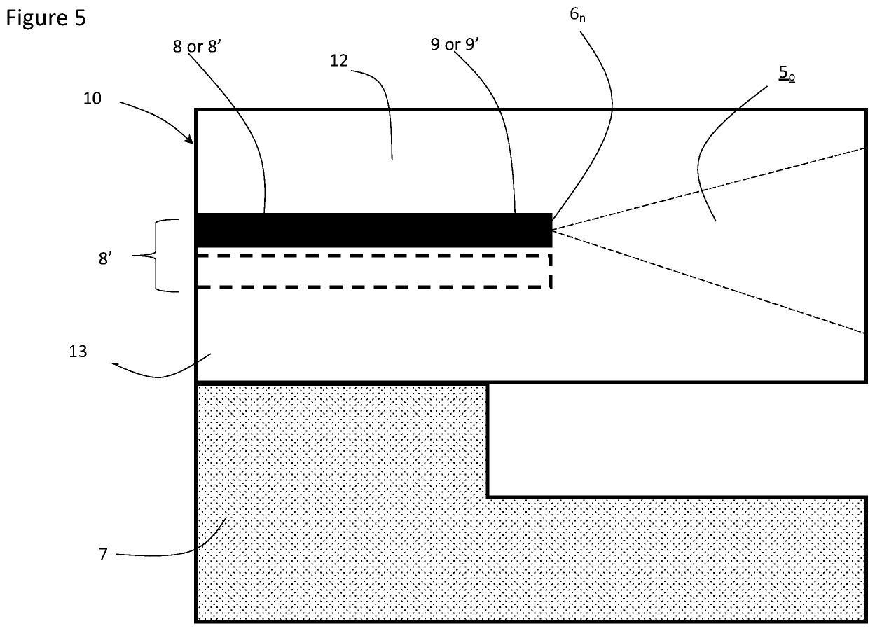

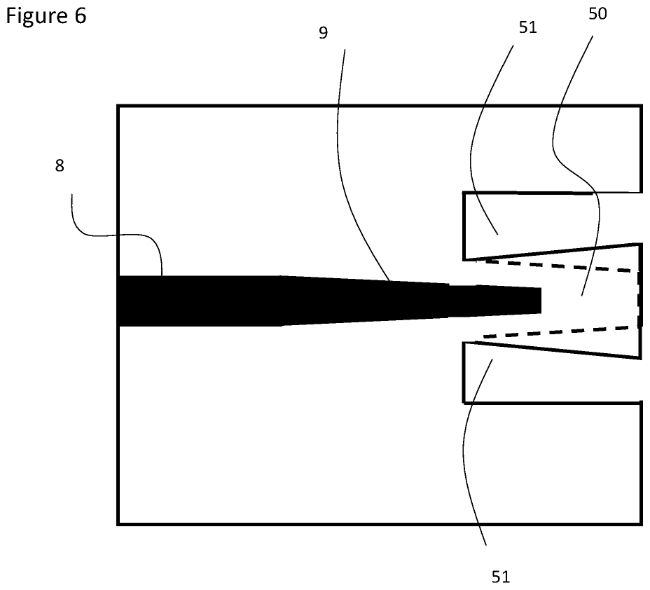

With reference to FIGS. 5 and 6, to further reduce the NA of the point emitters 6₁ to 6ₙ, a suspended optical waveguide structure 50 may be provided optically coupled to the end of some or each of the end-fire tapers 9 or 9′. The suspended optical waveguide structure 50 may be comprised of the cladding material, e.g. SiO₂, now forming the optical waveguide core, surrounded by a pocket of material with a lower index of refraction, e.g. air, forming cladding. The suspended optical waveguide structure 50 may be suspended above the main substrate 7 by removing, e.g. etching, one or more of the substrate material from the main substrate 7 and/or the cladding material from the upper and lower cladding 12 and 13 beneath and/or around the suspended optical waveguide structure 50 forming a pocket or chamber 51 around the suspended optical waveguide structure 50. Accordingly, the NA for suspended waveguide structure 50/end-fire tapers 9 or 9′ may be reduced to less than about 0.25, preferably less than about 0.2. The suspended optical waveguide structure 50 may extend about 2 μm to 50 μm into the chamber 51, whereas the end fire taper 9 or 9′ may extend somewhat into the chamber 51, but less than the full length of the suspended optical waveguide structure 50. The suspended optical waveguide structure 50 may have a thickness, e.g. about 6 μm to 8 μm, the same as the total optical emitter array 10, or may be made thinner than the optical emitter array 10 by the local removal of some of the upper cladding 12. The suspended optical waveguide structure 50 may have a constant width about the same as the thickness, e.g. about 6 μm to 8 μm. The suspended optical waveguide structure 50 may include tapering side and/or upper and/or lower walls, i.e. narrowing width and/or height towards the outer free end thereof (dashed lines) or may include reverse tapering side and/or upper and/or lower walls, i.e. widening width and/or height towards the outer free end thereof, i.e. along a light transmission direction. Ideally, the end-fire taper 9 or 9′ is positioned in the center both vertically and horizontally of the waveguide structure 50.

The lens system 3 may comprise a plurality of lens elements, if required. Most of the design of the lens system 3 is a compromise between the F-number, the field-of-view, and the aperture size. However, there may be a few design priorities: e.g. a) to have an image-plane telecentric design, where the chief rays from the point emitters 6₁ to 6ₙ are all parallel to the optical axis OA in the image space, b) reaching diffraction limit across the field-of-view, and c) the image space numerical aperture (NA) of the lens system 3 substantially matches or exceeds the NA of the point emitters 6₁ to 6ₙ. Minimizing the effect of lens curvature aberrations enables the smallest spread in the output beams 5ₒ and the best possible focusing for the receiving input beams 5ᵢ. The point emitters 6₁ to 6ₙ preferably emit output beams 5ₒ at a beam angle that may be fully captured and transmitted by the lens system 3. For example, if the NA of one or more of the point emitters 6₁ to 6ₙ is larger than the image space NA of the lens system 3, then a portion of the light emitting from the point emitters 6₁ to 6ₙ will not transmit through the lens system 3, therefore rendered as loss.

The optical device 1 may also include at least one light source, preferably an array of light sources, and at least one photodetector, preferably an array of photodetectors optically coupled to corresponding one or more point emitters 6₁ to 6ₙ in the optical emitter chip 2. Preferably, the array of light sources and the array of light detectors comprises an array of transceivers 11₁ to 11ₙ. Each transceiver 11₁ to 11ₙ may comprise a light source, e.g. laser, which generates at least one of the output beams 5ₒ, and one or more photodetectors, which detects at least one of the input beams 5ᵢ. Selectively sending and receiving light to and from the point emitters 6₁ to 6ₙ may be provided by a switching matrix 16 between the transceivers 11₁ to 11ₙ and the point emitters 6₁ to 6ₙ. Accordingly, to select a desired point emitter 6₁ to 6ₙ, corresponding to a desired beam angle α, the controller 20 may select one or more of the light sources in one of the transceivers 11₁ to 11ₙ, corresponding to one or more of the point emitters 6₁ to 6ₙ, in that row or column by turning on and/or off various switches 14 in the switching matrix 16. For example, with four point emitters 6₁ to 6₄ (m=4) in the row or column of point emitters 6₁ to 6ₙ, connected to the first transceiver 11₁, the switching matrix 16 may have a single input port optically coupling the first transceiver 11₁ to a first switch tree comprising (m−1=3) switches 14, e.g. 2×2 on-chip Mach-Zehnder interferometers (MZI), which can be selectively activated by the controller 20 to output the output beam 5ₒ to a desired output port. Any number of branches and switches 14 in the first switch tree, including direct coupling from each transceiver 11₁ to each point emitter 6₁ to 6ₙ, is possible. A plurality of optical waveguide cores 8 extend parallel to each other between the output ports of the switching matrix 16 and the point emitters 6₁ to 6ₙ. Ideally, the pitch of the point emitters 6₁ to 6ₙ in the optical emitter chip 2 is 5 μm to 1000 μm or based on the focal length f, size L of the optical emitter array 10 and the angular resolution required by the LIDAR system:

Pitch=resolution/(2*arctan(L/2f))*L

Similarly, when one of the incoming beams 5ᵢ is received at the same point emitter 6₁ to 6ₙ, the incoming beam 5ᵢ is transmitted in reverse via the corresponding optical waveguide core 8 to the switching matrix 16 back to the corresponding photodetector in the corresponding transceiver 11₁ to 11ₙ.

The optical emitter chip 2 may comprise any one or more of the n optical transceivers 11₁ to 11ₙ, the switching matrix 16, and the array of point emitters 6₁ to 6ₙ; however, any one or more of the n optical transceivers 11₁ to 11ₙ, and the switching matrix 16 may be on separate chips. At any instance, the laser output from one of the optical transceivers 11₁ to 11ₙ is routed to a specific end-fire taper 9 ending at near the edge of the optical emitter chip 2. Each point emitter 6₁ to 6ₙ, i.e. each end-fire taper 9, is configured to emit an output beams 5ₒ out of the edge of the optical emitter chip 2, after which each output beam 5ₒ expands and is directed towards the lens system 3. The edge of the optical emitter chip 2 is aligned on or near the focal plane F of the lens system 3, therefore the output beams 5ₒ, expanding from the end-fire taper 9, will be shaped, e.g. collimated, by the lens system 3 and then emitted to the far field. The far field angle of the output beams 5ₒ depends on the location of the point emitter 6₁ to 6ₙ relative to the optical axis OA of the lens system 3, therefore providing a one dimensional scanning of beams by selectively turning on each point emitters or multiple point emitters at the same time, e.g. depending on how many optical transceiver 11₁ to 11ₙ.

The second axis of the scan is provided by the rotating mirror 4. The output beam 5ₒ coming out of the lens system 3 hits one of the reflective surfaces or facets of the rotating mirror 4 and is redirected into the far field for object detection. The input beam 5ᵢ, corresponding to the output beam 5ₒ reflected from the object, may return via the same reflective surface and the lens system 3 to the originating point emitter 6₁ to 6ₙ, for capture by the corresponding photodetector, prior to the rotating mirror 4 rotating out of range, i.e. rotating enough to not be able to direct the corresponding input beam 5ᵢ substantially back to the same originating point emitter 6₁ to 6ₙ as the output beam 5ₒ in a round trip period, e.g. 0.5 ns to 5 μs for an object 7.5 cm to 750 m away. Typically, an output beam 5ₒ is launched by one of the light sources every 2 μs to 1000 μs. In other words, the optical device 1 chirps at about 1 kHz to 500 kHz, i.e. the output beam 5ₒ (continuous or pulsed) is launched every 2 μs to 1 ms.

For each round trip period, some or all of the point emitters 6₁ to 6ₙ may emit an output beam 5ₒ forming a plurality of beams of light in a same detection plane, but at different beam angles α covering an angular detection range, e.g. 10° to 90°. Each light source, e.g. each transceiver 11₁ to 11ₘ, may transmit a beam of light which is separated into sub-beams, e.g. 2-8 sub-beams, by the switching matrix 16, i.e. when all switches 14 are off or omitted entirely, and transmitting light to every waveguide core 8, which are then simultaneously transmitted by the point emitters 6₁ to 6ₙ.

To reduce the number of light sources and photodetectors required, while maintaining a maximum or desired threshold optical power, the controller 20 may also cycle through a group of the point emitters, e.g. 6₁ to 6₄, which are optically coupled to one of the transceivers, e.g. transceiver 11₁, by turning selected switches 14 on and off to sequentially transmit a different output beam 5ₒ to each of the point emitters, e.g. 6₁ to 6₄, in the group. Some or all of the light sources, e.g. some or all of the transceivers 11₁ to 11ₘ, may have a different group of waveguide cores 8 optically coupled thereto, whereby a first subset of output beams 5ₒ may be transmitted simultaneously at a time, i.e. one output beam 5ₒ from each light source transmitted via one of the group of waveguide cores 8 coupled thereto. Then, under control of the controller 20, each light source will sequentially cycle through each of the waveguide cores 8 in the corresponding group of waveguide cores 8 coupled thereto, spending at least a single round trip period switched to each emitter, e.g. 6ᵢ-6₄. The round trip period should be at least as long as the time necessary for the light to travel from the light source of the point emitter, e.g. 6₁ to 6₄, to the target and back to the photodetector of the point emitter, e.g. 6₁ to 6₄. Accordingly, only a portion of the total number of output beams 5ₒ (and the input beams 5ᵢ) to cover the full range of beam angles α may be transmitted at one time. The controller 20 may coordinate the light sources, the switching matrix 16, an angular position of the rotating mirror 4, and the photodetectors to transmit and receive each output beam 5ₒ and each input beam 5ᵢ sequentially via the first switching matrix 16 and the plurality of first point emitters 6ᵢ-6ₙ.

As the rotating mirror 4 rotates, one or more output beams 5ₒ may then be scanned, i.e. rotated, through a predetermined scanning range, e.g. angle, depending on the number of facets and the size of the facets on the rotating mirror 4. There are ranges of angles for which the output beams 5ₒ (and input beams 50 falling on one of the facets of the rotating mirror 4 are not clipped at the edges, and the total optical scanning range is twice that angular range. One can define a duty cycle as the percentage of the full rotation cycle where the output and input beams 5ₒ and 5ᵢ are fully incident on a facet of the rotating mirror 4 without clipping. For example, four facets with a size of 30×30 mm square face provides a scanning range of about 100° with a duty cycle of 60%, and three facets with a size of the same size provides a scanning range of about 120° with a duty cycle of 50%. As the rotating mirror 4 rotates, the angle of each facet relative to the output beams 5ₒ continuously changes through the range of angles between a first minimum angle i.e. directed at a first edge or corner of the rotating mirror 4 redirecting the output beams to one side of the rotating mirror 4 (FIG. 2A), to substantially perpendicular (intermediate angle) after which the output beams 5ₒ are redirected to a far side of the rotating mirror 4, then to a second maximum angle, i.e. directed at a second edge or corner of the rotating mirror 4 (FIG. 2B). After the maximum angle of each facet, the output beams 5ₒ will sequentially hit and be redirected by the subsequent facets, and proceed through the scanning range of angles from the first minimum angle to the intermediate angle to the second maximum angle again for each facet of the rotating mirror 4.

When the output beams 5ₒ are directed at an edge of the rotating mirror 4 between facets, the light may scatter in different directions, accordingly, the controller 20 may reduce or eliminate any incorrect readings by one or more error mitigating schemes by coordinating the position of the rotating mirror 4 with the control of the light sources and the photodetectors, such as turning off the light sources and/or the photodetectors in transceivers 11₁ to 11ₙ for a period of time while the output beams 5ₒ are directed at an edge or by simply disregarding any readings from the photodetectors for the period of time while the output beams 5ₒ are directed at an edge.

The rotating mirror 4 may be comprised of a polygonal prism, comprising a plurality, e.g. 3 or 4 or 5 or 6, of facets, each comprising a reflective surface, and with a longitudinal axis of rotation 24, which may or may not be aligned with a rotational axis of a spinning motor 25. The spinning motor 25 may be any type of rotary motor, such as a stepper motor, dc motor, or servo motor. The longitudinal axis of rotation 24 may not be aligned to the axis of the spinning motor 25 when the axes are connected with a belt or gear system. The longitudinal axis of rotation 24 of the rotating mirror 4 may be perpendicular to the optical axis OA of the lens system 3 and/or parallel to a first plane in which the emitter array 10 lies. The optical axis OA may lie in a second plane perpendicular to the first plane and perpendicular or normal to the axis of rotation 24.

Direct reflection of the output beam 5ₒ directly back into the point emitter 6₁ to 6ₙ, i.e. the end-fire taper 9, may be prevented, and the field of view (FOV) may be increased, by disposing the longitudinal axis of rotation 24 of the rotating mirror 4 offset, distance t, from the optical axis OA of the lens system 3, i.e. the axis of rotation 24 may not intersect with the optical axis OA. Generally, the unobstructed FOV range begins at a position where the output beam 5ₒ misses the lens system 3 (back reflected) and ends when the output beam 5ₒ begins to clip the edges of the mirror facet.

There may be dead zones, in which no accurate transmit/return measurements are possible, created by the corners of the rotating mirror 4, which depend on the size and number of the facets.

The rotational speed (revolutions per second, or rps) of the rotating mirror 4 depends on the switching scheme; however, the rotational speed may be the same speed as or less than the LIDAR frame rate, i.e. how long it takes to scan the entire scanning range. For example, for 3 frames/second, divided by the number of facets, e.g. 3-6 facets, equals e.g. 1-0.5 rps. The rotational speed is preferably kept less than a threshold speed, at which errors may occur if the sweep is too fast such that the input beam 5ᵢ does not reflect back to the same point emitter 6₁-6ₙ (or even hitting nothing). Ideally, this means that the motor angular velocity (in degrees per second), e.g. between 1 and 50 rps, or 360 and 18000 degrees per second, is less than the input beam 5ᵢ divergence (in degrees), e.g. between 0.2° and 0.002°, divided by the round-trip time for the light to travel from the mirror system 3 to the target and back (in seconds). For example, for a beam divergence of 0.02° and a target 500 m away, the round-trip time would be 3.33 μs, so the mirror would ideally turn more slowly than 0.02 degrees/3.33 μs, i.e. 6000 degrees/s or roughly 17 rps./#facets.

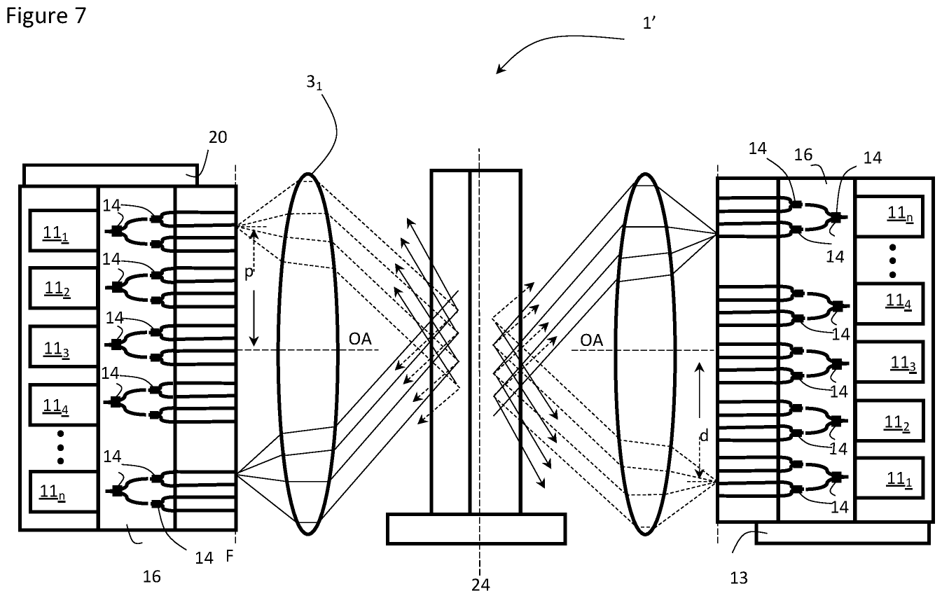

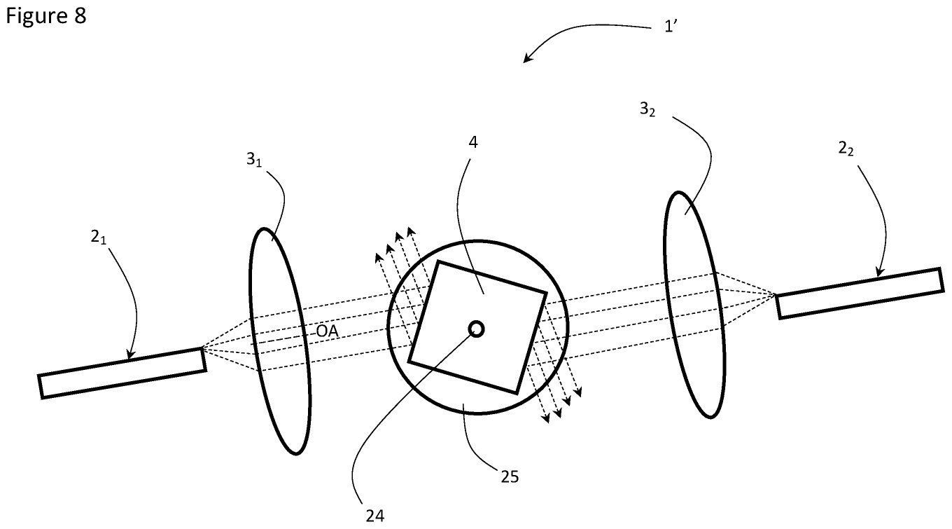

With reference to FIGS. 7 and 8, an exemplary optical emitter device 1′ includes a plurality of optical emitter chips 2ᵢ to 2ₙ and corresponding lens systems 3₁ to 3ₙ sharing a single polygonal rotating mirror 4. The benefit of this approach is to expand the field-of-view in one system. A smaller number of facets, e.g. 3 to 6, is desired to keep the volume size of the rotating mirror 4 relatively small.

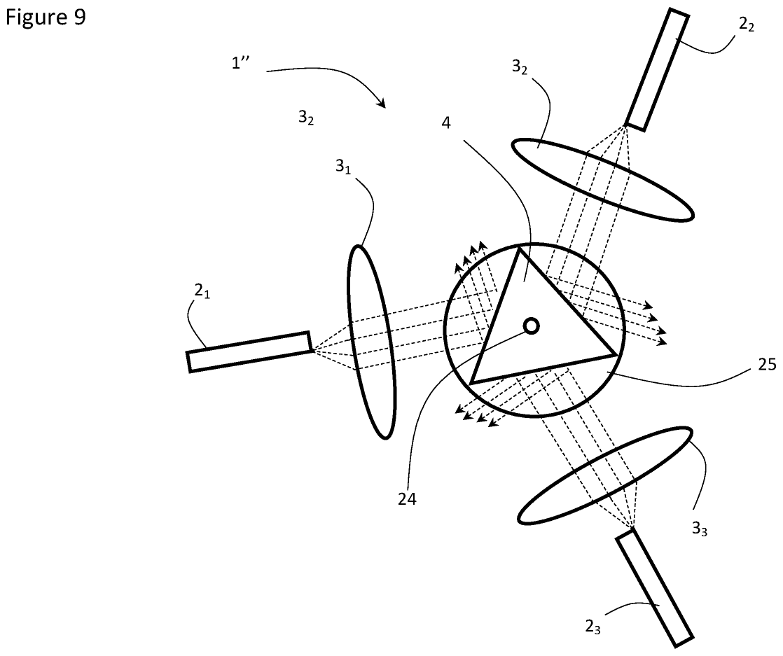

FIG. 9 illustrates an exemplary optical emitter device 1″ in which three sets of optical emitter chips 2ᵢ to 2ₙ and corresponding lens systems 3₁ to 3ₙ share a single triangular polygonal reflecting mirror 4.

The term controller or processor may include a microcontroller or a field-programmable-gate-array (FPGA) including with suitable non-transitory memory for storing the control parameters via computer software.

To control the system, when the spinning motor 25 is a stepper motor, the controller 20 may include a dedicated microcontroller or FPGA controller that send control signals, e.g. pulses, to step the spinning (stepper) motor 25 in fixed increments. Therefore, the microcontroller or the FPGA may immediately determine the instantaneous position, i.e. angle, of the rotating mirror 4 based on the control signals. To avoid asynchronized control over time due to the possibly that the spinning (stepper) motor 25 misses steps, an optical slotted interrupter may be installed in the rotating mirror 4/spinning motor 25 system. An interrupt pin may also be installed on either end of rotating mirror 4, which may slide in and out of the optical slotted interrupter thereby temporarily blocking light detection in the optical slotted interrupter as the spinning motor 25 and/or rotating mirror 4 rotates. Therefore, the optical interrupter will provide a pulse signal to the microcontroller/FPGA for every rotation of the rotating mirror 4 and/or the spinning motor 25.

For all types of spinning motors 25, there may be a dedicated rotary encoder either built-in the spinning motor 25 or an external rotary encoder module that provides the absolute or relative angular position of the rotating mirror 4 to the microcontroller/FPGA.

When the controller 20, e.g. the microcontroller/FPGA, has the angular position of the rotating mirror 4, a correct lidar image may be constructed.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. An optical emitter device comprising:
a first emitter array comprising a plurality of first point emitters, each respective first point emitter configured to emit a respective first beam of light;
a first lens system configured to shape and direct each respective first beam of light based on a position of each respective first point emitter relative to a first optical axis of the first lens system; and
a rotating reflector configured to redirect each respective first beam of light at an angle to the first optical axis.

2. The optical emitter device according to claim 1, wherein the first emitter array lies in a first plane substantially parallel to an axis of rotation of the rotating reflector.

3. The optical emitter device according to claim 2, wherein the first optical axis of the first lens system lies in a second plane that is perpendicular to the first plane and normal to the axis of rotation of the rotating reflector.

4. The optical emitter device according to claim 1, wherein the rotating reflector comprises a polygonal prism including a plurality of facets.

5. The optical emitter device according to claim 1, further comprising:
a second emitter array comprising a plurality of second point emitters, each respective second point emitter configured to emit a respective second beam of light; and
a second lens system configured to shape and direct each respective second beam of light based on a position of each respective second point emitter relative to a second optical axis of the second lens system;
wherein the rotating reflector is configured to redirect the respective second beam of light.

6. The optical emitter device according to claim 5, wherein the rotating reflector comprises a polygonal prism including a plurality of facets, and rotatable about an axis of rotation; and
wherein each of the first emitter array and the second emitter array is directed at a different one of the plurality of facets.

7. The optical emitter device according to claim 6, wherein the axis of rotation is substantially parallel to a first plane including the first emitter array, and substantially parallel to a second plane including the second emitter array.

8. The optical emitter device according to claim 6, wherein the axis of rotation is offset from the first optical axis.

9. The optical emitter device according to claim 5, further comprising:
a third emitter array comprising a plurality of third point emitters, each respective third point emitter configured to emit a respective third beam of light; and
a third lens system configure to shape and direct each respective third beam of light based on a position of each respective third point emitter relative to a third optical axis of the third lens system;
wherein the rotating reflector is configured to redirect the respective third beam of light.

10. The optical emitter device according to claim 9, wherein the rotating reflector comprises a polygonal prism including three facets, and rotatable about an axis or rotation; and
wherein each of the first emitter array, the second emitter array and the third emitter array is directed at a different one of the three facets.

11. The optical emitter device according to claim 10, wherein the axis of rotation is perpendicular to the first optical axis of the first lens system, the second optical axis of the second lens system, and the third optical axis of the third lens system.

12. The optical emitter device according to claim 1, wherein an outer end of at least some of the plurality of first point emitters are disposed substantially at a first focal plane of the first lens system.

13. The optical emitter device according to claim 12, wherein the first focal plane of the first lens system comprises a substantially curved section; and wherein the outer end of at least some of the plurality of first point emitters is disposed proximate to the first focal plane.

14. The optical emitter device according to claim 13, wherein the first emitter array further comprises a trench, a curved edge of which is proximate to the curved section of the first focal plane.

15. The optical emitter device according to claim 12, wherein the plurality of first point emitter comprise a plurality of first end-fire tapers; and wherein a longitudinal central axis of at least some of the plurality of first end-fire tapers is at an acute angle to the first optical axis substantially aligned with a corresponding chief ray of the first lens system.

16. The optical emitter device according to claim 12, wherein the plurality of first point emitters are irregularly spaced.

17. The optical emitter device according to claim 1, further comprising:
a main substrate for supporting the plurality of first point emitters, wherein the plurality of first point emitters comprises a plurality of end-fire tapers; and
an optical waveguide structure, comprising:
a plurality of optical waveguide cores, each one of the plurality of optical waveguide cores comprising a main optical waveguide extending to a corresponding one of the end-fire tapers; and
cladding surrounding the plurality of optical waveguide cores.

18. The optical emitter device according to claim 17, wherein at least one of the plurality of optical waveguide cores comprises a bi-layer optical waveguide core.

19. The optical emitter device according to claim 18, wherein at least one of the bi-layer optical waveguide core comprises a first layer of silicon and a second layer of silicon nitride.

20. The optical emitter device according to claim 17, wherein at least one of the plurality of end fire tapers includes a suspended optical waveguide extending therefrom;
wherein the suspended optical waveguide comprises a suspended waveguide core comprising a same material as the cladding, surrounded by a pocket provided in the optical waveguide structure and the main substrate comprising cladding material with a lower index of refraction than the suspended waveguide core.

21. The optical emitter device according to claim 20, wherein each suspended optical waveguide includes tapering side walls, which widen or narrow in width along a light transmission direction.

22. The optical emitter device according to claim 17, wherein at least some of the plurality of first end-fire tapers narrow to between 50 nm and 400 nm in width.

23. The optical emitter device according to claim 17, wherein at least some of the plurality of first end-fire tapers expand to between 1 μm and 4 μm in width.

24. The optical emitter device according to claim 1, further comprising:
at least one light source for generating the respective first beams of light; and
a first switching matrix for selectively directing the respective first beams of light to one of the plurality of point emitters.

25. The optical emitter device according to claim 24, further comprising at least one photodetector for detecting incoming beams of light received by the plurality of point emitters.

26. The optical emitter device according to claim 25, further comprising a controller configured to coordinate the at least one light source, the first switching matrix, an angular position of the rotating reflector, and the at least one photodetector to transmit and receive each first beam of light sequentially via the first switching matrix and the plurality of first point emitters.
